(19) United States
(12) Patent Application Publication
(10) Pub. No.: US 2021/0229723 A1
(43) Pub. Date: Jul. 29, 2021

(54) CART HANDLE ASSEMBLY WITH POWER ASSIST FUNCTION AND CART HAVING THE SAME

(71) Applicant: LG ELECTRONICS INC., Seoul (KR)

(72) Inventors: Jaecheon SA, Seoul (KR); Sunryang KIM, Seoul (KR); Joohan KIM, Seoul (KR); Keunsik NO, Seoul (KR)

(73) Assignee: LG ELECTRONICS INC., Seoul (KR)

(21) Appl. No.: 16/757,865

(22) PCT Filed: Apr. 8, 2019
(86) PCT No.: PCT/KR2019/004167

§ 371 Date: Apr. 21, 2020

(51) Int. Cl. B62B 5/00; B62B 5/06

(52) U.S. Cl. CPC B62B 5/0073; B62B 5/0033; B62B 5/06

(57) ABSTRACT

Disclosed herein are a cart handle assembly with power assist function, which enables a user to easily move a cart by detecting a direction, in which a user's force is applied, to assist power in that direction, and a cart having the same. According to the disclosure, it is possible to improve user's convenience since a user can easily move a cart by detecting a direction, in which a user's force is applied, to provide an assist force (power assist function) in that direction.

### TECHNICAL FIELD

The present invention relates to a cart handle assembly with power assist function and a cart having the same.

### BACKGROUND ART

Various types of carts are used in order for a user to carry heavy objects or luggage in large supermarkets or department stores, airports, or the like.

A cart used in a shopping space such as a large supermarket or a department store has a structure in which it has a plurality of wheels installed at the lower portion of a basket for storing an object so that a user moves the cart by pushing or pulling a handle. Examples of a cart used in an airport or the like include a cart similar to the above-mentioned cart, and a cart having an additional brake function.

The cart is a necessary product for user's convenience since it prevents a user from directly holding and carrying many or heavy objects. However, loading and carrying many or heavy objects causes inconvenience even if the cart is used because the user can move the cart by applying a lot of force.

In addition, when a sensor is used to detect the direction of the force applied for movement of the cart, vibration is generated in a vertical direction besides forward and rearward directions due to the movement because the cart runs on the ground, which leads to the complexity of control for accurate detection. Therefore, it is necessary to develop a cart capable of avoiding complicated control while accurately detecting the force applied to the cart.

### DISCLOSURE

### Technical Problem

It is an object of the present invention is to provide a cart handle assembly with power assist function, which enables a user to easily move a cart by detecting a direction, in which a user's force is applied, to assist power in that direction, and a cart having the same.

It is another object of the present invention is to provide a cart handle assembly with power assist function, which is capable of distinguishing a direction, in which a user's force is applied, from noise through simple structure to assist power in that direction, and a cart having the same.

The present invention is not limited to the above-mentioned objects, and other objects and advantages of the present invention can be understood by the following description and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with an aspect of the present invention, there is provided a cart handle assembly that includes a handle bar provided at one side of a cart, an external force applied in a direction of movement of the cart being input to the handle bar, and a force sensing module including a connection bracket connected to each of both sides of the handle bar and installed at an upper side of a body of the cart, the connection bracket being moved in a direction of the external force input to the handle bar, a force sensor coupled to the connection bracket to detect a direction of movement of the connection bracket, and a support frame for supporting the force sensor.

The force sensor may be a bar-type load cell, one end of which is coupled to the connection bracket while the other end thereof is coupled to the support frame.

The support frame may be fixed to the upper side of the body of the cart to support the other end of the force sensor.

The cart handle assembly may further include a handle cover frame coupled to each of both ends of the handle bar to support the handle bar, and a handle support frame inserted into the handle cover frame, one end of the handle support frame extending downward to be coupled to the connection bracket.

In accordance with another aspect of the present invention, there is provided a cart handle assembly that includes a handle bar provided at one side of a cart, an external force applied in a direction of movement of the cart being input to the handle bar, and a force sensing module including a connection bracket connected to each of both sides of the handle bar and installed at a lower side of a body of the cart, the connection bracket being moved in a direction of the external force input to the handle bar, a force sensor coupled to the connection bracket to detect a direction of movement of the connection bracket, and a support frame for supporting the force sensor.

The force sensor may be a bar-type load cell, one end of which is coupled to the connection bracket while the other end thereof is coupled to the support frame.

The support frame may be fixed to the lower side of the body of the cart to support the other end of the force sensor.

The cart handle assembly may further include a handle cover frame, one end of which is coupled to each of both ends of the handle bar to support the handle bar while the other end thereof extends downward, and a handle support frame inserted into the handle cover frame, one end of the handle support frame extending downward to be coupled to the connection bracket.

The cart handle assembly may further include a first subframe, one end of which is coupled to a lower end of the handle support frame while the other end thereof extends downward, a second subframe, one end of which is rotatably coupled to one side of the first subframe while the other end thereof extends downward to be coupled to the body of the cart, and a hinge part for rotatably coupling the first subframe to the second subframe.

The connection bracket may be coupled to a lower end of the first subframe.

In accordance with still another aspect of the present invention, there is provided a cart that includes a body including a drive unit for generating electric power and a control unit for controlling the drive unit, a plurality of wheels coupled to a lower portion of the body to move the body, a handle bar provided at one side of the body, an external force applied in a direction of movement of the body being input to the handle bar, and a force sensing module including a connection bracket connected to each of both sides of the handle bar and installed at an upper side of the body, the connection bracket being moved in a direction of the external force input to the handle bar, a force sensor coupled to the connection bracket to detect a direction of movement of the connection bracket, and a support frame for supporting the force sensor, wherein the control unit transmits the power generated by the drive unit to the wheels according to the direction of movement of the support frame detected by the force sensor.

The force sensor may be a bar-type load cell, one end of which is coupled to the connection bracket while the other end thereof is coupled to the support frame.

The support frame may be fixed to the upper or lower side of the body of the cart to support the other end of the force sensor.

The cart may further include a handle cover frame coupled to each of both ends of the handle bar to support the handle bar, and a handle support frame inserted into the handle cover frame, one end of the handle support frame extending downward to be coupled to the connection bracket.

In accordance with a further aspect of the present invention, there is provided a cart that includes a body including a drive unit for generating electric power and a control unit for controlling the drive unit, a plurality of wheels coupled to a lower portion of the body to move the body, a handle assembly including a handle bar to which a force applied in a direction of movement of the body is input, and a handle support frame extending downward from the handle bar to downwardly transmit the force applied to the handle bar, and a force sensing module including a force sensor installed on the body facing the handle bar to detect the force transmitted from the handle support frame, and a support frame for supporting the force sensor, wherein the control unit transmits the power generated by the drive unit to the wheels according to the direction of movement of the handle bar detected by the force sensor.

The force sensor may be a bar-type load cell having one end as a fixed end coupled to the handle support frame and the other end as a free end, the bar-type load cell being deformed by the force transmitted from the handle support frame to detect the force.

The handle assembly may further include a subframe rotatably coupled to a lower end of the handle support frame to transmit the force applied to the handle support frame to the force sensor.

The subframe may have a rotating part disposed at a position adjacent to the force sensor.

### Advantageous Effects

According to the present invention, it is possible to improve a user's convenience since a user can easily move a cart by detecting a direction, in which a user's force is applied, to provide an assist force (power assist function) in that direction.

In addition, according to the present invention, it is possible to separate a force applied to a handle from noise by installing a load cell at an optimum position that allows the force to be distinguished from the vibration transmitted from the ground. Therefore, it is possible to perform accurate detection without being affected by noise and to achieve an increase in control efficiency and a reduction in manufacturing cost since a complicated control algorithm is not required for noise separation.

In addition, it is possible to easily separate the magnitude of force applied for movement of the cart from the vibration transmitted from the ground by decoupling the load cell from the handle, as a point of action to which a force is applied, to install the load cell at the lower portion of a cart body and by amplifying the force applied to the handle to transmit the amplified force to the load cell. Therefore, it is possible to achieve an increase in control efficiency and a reduction in manufacturing cost since the complicated control algorithm is not required for noise separation.

Furthermore, since the load cell is not directly mounted on the handle but is mounted on the upper or lower portion of the cart body, which is beneath the handle, the internal structure of the handle can be simply designed and the size of the handle can be reduced. Since the load cell is mounted on the cart body, not the handle, it is possible to easily access the load cell by opening the cover of the cart body without removing the handle, thereby providing easy maintenance.

In addition to the effects described above, the specific effects of the present invention will be described together with the following detailed description for carrying out the disclosure.

### BRIEF DESCRIPTION OF DRAWINGS

FIG. 1 is a perspective view illustrating a cart according to exemplary embodiments of the present invention.

FIG. 2 is a rear perspective view illustrating the rear of a cart according to a first embodiment of the present invention.

FIG. 3 is a perspective view illustrating the handle assembly of FIG. 2.

FIG. 4 is an exploded perspective view illustrating the handle assembly of FIG. 3.

FIG. 5 is a rear view illustrating the rear of the handle assembly of FIG. 3.

FIG. 6A is a perspective view illustrating a handle assembly according to a second embodiment of the present invention.

FIGS. 6B and 6C are views illustrating a handle assembly according to a modified example of the second embodiment.

FIG. 7 is a rear perspective view illustrating the rear of a cart according to a third embodiment of the present invention.

FIG. 8 is a perspective view illustrating the handle assembly of FIG. 7.

FIG. 9 is an enlarged perspective view illustrating a main part of the handle assembly of FIG. 7.

FIG. 10 is an exploded perspective view illustrating the handle assembly of FIG. 7.

### MODE FOR INVENTION

The above objects, features, and advantages will be described in detail with reference to the accompanying drawings, whereby the technical idea of the present invention may be easily implemented by those skilled in the art to which the present invention pertains. In certain embodiments, detailed descriptions of technologies well known in the art may be omitted to avoid obscuring appreciation of the disclosure. Exemplary embodiments of the present invention will be described below in detail with reference to the accompanying drawings. In the drawings, the same reference numbers will be used to refer to the same or like parts.

In the following description, placing an element on the “top (or bottom)” of another element or “above (or below)” another element may mean that not only can it be in contact with the “upper surface (or lower surface)” of the other element, but also can other elements be interposed between the elements.

It will be understood that, when an element is referred to as being “connected”, “coupled”, or “joined” to another element, not only can it be directly “connected”, “coupled”, or “joined” to the other element, but also can it be indirectly “connected”, “coupled”, or “joined” to the other element with other elements interposed therebetween.

The term “cart”, as used hereinafter, refers to a device that manually moves under the control of a user or moves by electric power provided thereto. The cart may or may not include an object storage function. The cart may be used in all spaces, for example, in a shopping space such as a large supermarket or department store or a small and medium-sized store, in a leisure space such as a golf course, and in a moving space such as an airport or a harbor.

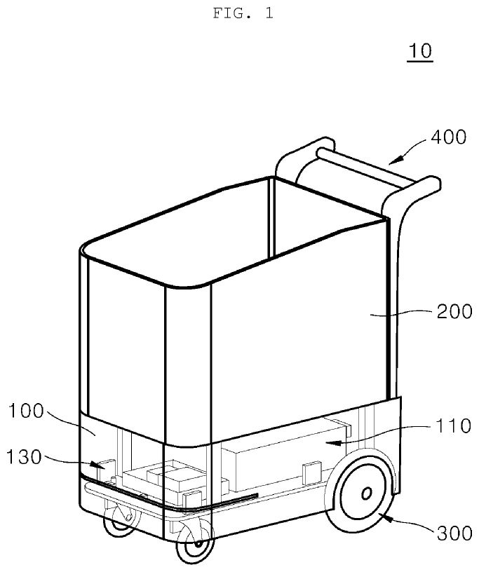

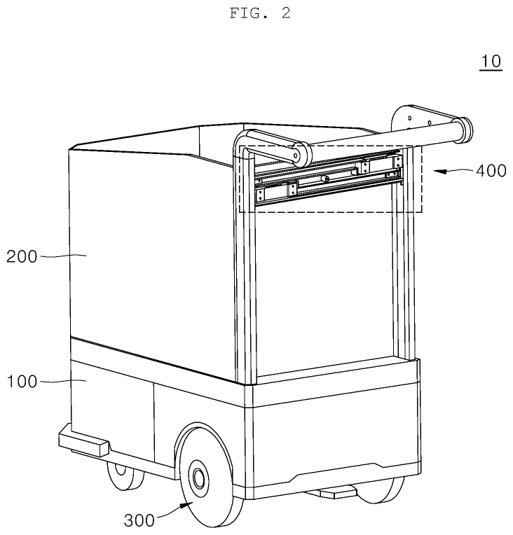

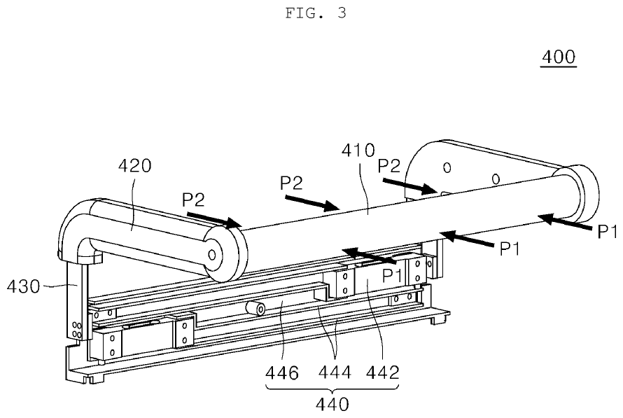

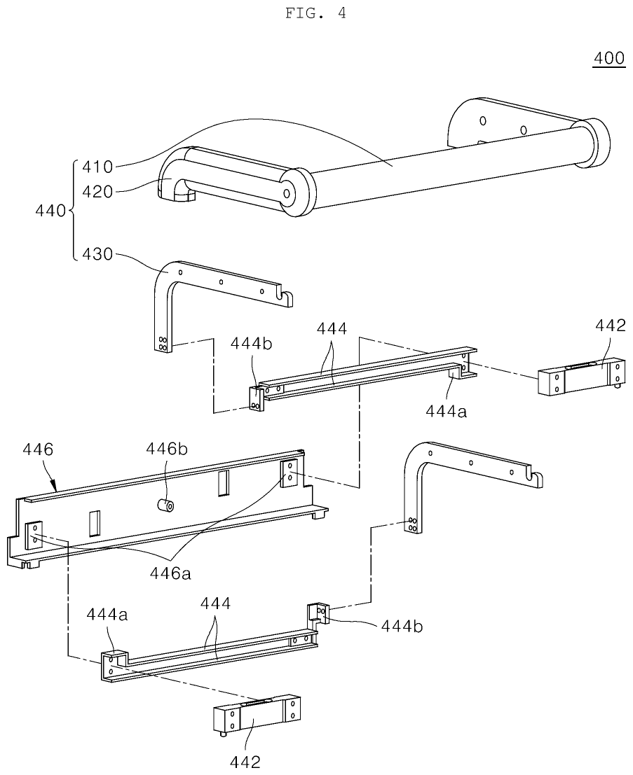

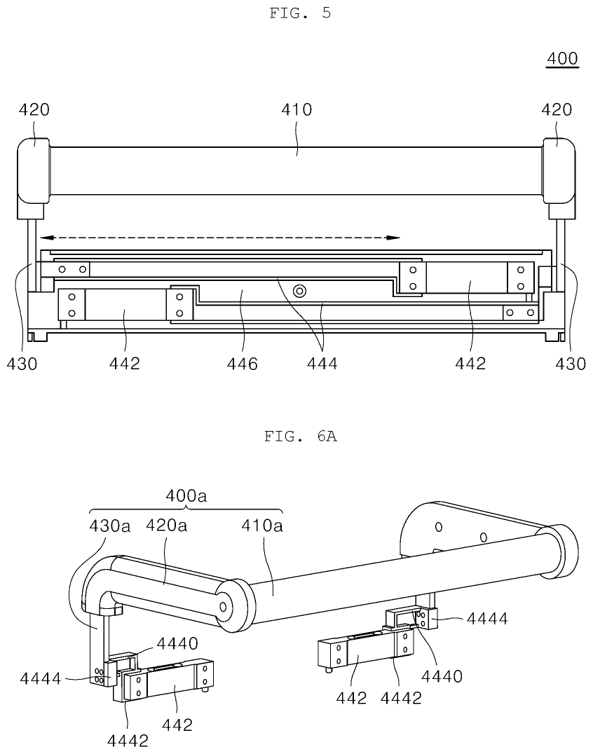

FIG. 1 is a perspective view illustrating a cart according to exemplary embodiments of the present invention. FIG. 2 is a rear perspective view illustrating the rear of a cart according to a first embodiment of the present invention. FIG. 3 is a perspective view illustrating the handle assembly of FIG. 2. FIG. 4 is an exploded perspective view illustrating the handle assembly of FIG. 3. FIG. 5 is a rear view illustrating the rear of the handle assembly of FIG. 3.

As illustrated in FIG. 1, the cart, which is designated by reference numeral 10, according to the embodiment of the present invention includes a body 100 equipped with a drive unit 110 and a control unit 130, a storage 200 provided at one side of the body 100, a plurality of wheels 300 coupled to the lower portion of the body 100, and a handle assembly 400 coupled to one side of the body 100 or storage 200. The handle assembly 400 includes a handle bar 410 grasped by a user, a handle cover frame 420 and a handle support frame 430 for supporting the handle bar 410, and a force sensing module 440 for detecting a direction of force desired by the user.

The body 100 may have a substantially hexahedral shape, and various components are mounted in the body 100. The body 100 may be equipped therein with the drive unit 110 for providing electric power to the wheels 300 and the control unit 130 for performing overall control of the cart 10. Although not illustrated in the drawings, the body 100 may be equipped with various sensors or controllers or the like required for running of the cart 10.

The drive unit 110 may include a battery, a motor, and so on. The drive unit 110 may provide an assist force to at least some of the wheels 300 under the control of the control unit 130. When the assist force is provided to the associated wheel(s) 300, a further force is added in the direction in which a user applies a force, thereby enabling the user to easily move the cart 10. Such a function of providing the assist force required to move the cart is defined as a “power assist” function in the present invention.

The control unit 130 may determine the direction of the force applied by the user through the force sensing module 440 provided on the handle assembly 400 and control the cart 10 to move in that direction. The control range of the control unit 130 may include whether the drive unit 110 is operated, a transmission direction of the assist force generated by the drive unit 110, and a resultant direction of rotation of the wheels 300.

For example, when it is detected that the user intends to move forward, the control unit 130 may control a driving force transmission direction such that the wheels 300 rotate forward after electric power is generated by operating the drive unit 110. On the contrary, when it is detected that the user intends to move rearward, the control unit 130 may control a driving force transmission direction such that the wheels 300 rotate rearward after electric power is generated by operating the drive unit 110.

To this end, the control unit 130 communicates with and controls the force sensing module 440 and the drive unit 110. In addition, the control unit 130 may directly control the direction of rotation of the wheels 300, or may control the direction of rotation of the wheels 300 by connecting the drive unit 110 to the wheel 300 and then controlling the power transmission direction of the drive unit 110.

The storage 200 may be provided at the upper side of the body 100. However, the storage 200 may also be disposed on the side, front, rear, or the like of the body 100 according to the place of use or the purpose.

The plurality of wheels 300 are provided and rotatably coupled to the lower portion of the body 100. In the present invention, the wheels 300 consist of two front wheels and two rear wheels. The rear wheels 300 may manually rotate when the user pushes the cart 10, or may semi-automatically or automatically rotate by the electric power transmitted from the drive unit 110. The rear wheels 300 may be larger in size than the front wheels 300.

The handle assembly 400 is provided behind the body 100 and the storage 200. The handle assembly 400 may be coupled to the storage 200 or the body 100. The handle assembly 400 may include the handle bar 410 grasped by the user, the handle cover frame 420 and handle support frame 430 for supporting the handle bar 410, and the force sensing module 440 installed adjacent to the handle bar 410.

As illustrated in FIG. 2, the handle bar 410 is a straight bar, and its external appearance is defined by a plurality of frames. The handle bar 410 may define an accommodation space together with the frames. The force sensing module 440 may be mounted in the accommodation space, and some components of the force sensing module 440 may be exposed out of the handle bar 410.

In FIG. 3, reference numeral “P1” refers to the direction of the force applied to the cart 10 by the user for forward movement. Reference numeral “P2” refers to the direction of the force applied to the cart 10 by the user for rearward movement. The user pushes the cart 10 in the P1 direction when attempting to move forward, and pulls the cart 10 in the P2 direction when attempting to move rearward. These directions of force may be detected by the force sensing module 440 and transmitted to the control unit 130 so as to be used for provision of the power assist function.

As illustrated in FIGS. 3 and 4, the handle cover frame 420 consists of a pair of handle cover frames to support the straight handle bar 410 at both ends thereof. One end of each of the handle cover frames 420 is coupled to one end of the handle bar 410 and the other end thereof is bent downward in a streamlined shape. The handle cover frame 420 has a receiving space defined along its shape therein. The handle support frame 430 is inserted into the receiving space.

The handle support frame 430 is a part forming the frame of the handle assembly 400. The handle support frame 430 is inserted into each of the handle cover frames 420. Therefore, the handle support frame 430 consists of a pair of handle support frames as well.

The handle bar 410 or the handle cover frames 420 may be made of a nonmetallic material, but the handle support frames 430 may be made of a metallic or high-rigidity material. The handle support frames 430 support forces (external forces) applied to the handle bar 410 and transmit the external forces to the force sensing module 440. To this end, the handle support frames 430 are connected to the force sensing module 440. Exactly, the handle support frames 430 are coupled to a connection bracket 444 of the force sensing module 440.

As illustrated in FIGS. 2 to 4, the force sensing module 440 may be disposed at the rear upper end of the body 100, namely, between the lower sides of the handle support frames 430. The force sensing module 440 may be coupled to the storage 200 in the rear thereof, or may be coupled to a separate frame supporting the storage 200. The force sensing module 440 includes a force sensor 442 for detecting the direction of the force applied to the handle bar 410, a connection bracket 444 to which the force sensor 442 is mounted, and a support frame 446.

The force sensor 442 is a sensor for measuring a direction of external force which is a force applied to the handle bar 410 by the user. All types of sensors may be used as the force sensor 442 as long as they may detect the direction of force. In the present invention, the force sensor 442 will be described as an example of a load cell.

The load cell is a load sensor using an elastic body that is proportionally deformed by an external force and a strain gauge that converts the degree of deformation of the elastic body into an electrical signal. When mass is applied to the elastic body, elastic behavior occurs and a resistance change corresponding to the applied mass occurs in the strain gauge. The load cell may detect a load change by converting the resistance change into an electrical signal in an electric circuit.

Depending on the shape of the load cell, there are various types of products, for example, a bar-type load cell for measuring a pushing or pulling force, a cylindrical load cell for measuring a pressing force, and an S-shaped load cell for measuring a pulling force.

In the present invention, a bar-type load cell is used as the force sensor 442 to measure the direction of the force pushing or pulling the handle bar 410. When the handle bar 410 is pushed in the P1 or P2 direction for forward or rearward movement of the cart 10, the force transmitted to each handle support frame 430 is transmitted to the force sensor 442 through the connection bracket 444. Since the detected value of the force sensor 442 is changed depending on the direction of the force transmitted to the force sensor 442, the control unit 130 may thus determine the direction of the force applied to the handle bar 410 (which will be described later).

The force sensor 442 consists of a pair of force sensors to detect the external forces transmitted through the pair of handle support frames 430, respectively. Since each of the force sensors 442 is of a bar type, one end thereof is coupled to the connection bracket 444 and the other end thereof is coupled to the support frame 446. The one end of the force sensor 442 coupled to the connection bracket 444 is a free end. The other end of the force sensor 442 coupled to the support frame 446 is a fixed end. Accordingly, the free end of the force sensor 442 is deformed when a force is applied to the connection bracket 444. The resistance value of the force sensor 442 is changed by the deformation of the free end so that the direction of external force may be determined.

In the present invention, the end of the force sensor being a “free end” does not mean that the end is movable in all directions without being coupled or fixed somewhere, but means that the end is coupled or fixed somewhere in the direction that does not affect the deformed displacement by the force applied thereto.

The connection bracket 444 is a straight bracket formed in the longitudinal direction of the handle bar 410, and consists of a pair of brackets having the same structure. Each of the connection brackets 444 may have a length shorter than the handle bar 410 and longer than each force sensor 442. The connection bracket 444 may have a substantially “E” shape in cross-section.

One end of each connection bracket 444 is coupled to an associated one of the handle support frames 430, and this part is defined as a frame coupling part 444b. The other end of the connection bracket 444, which is a free end, is coupled to one end of an associated one of the force sensors 442, and this part is defined as the sensor seating part 444a. The force sensor 442 is coupled to the sensor seating part 444a of the connection bracket 444, but has a free end that is not fixed on the support frame 446. These coupling parts are coupled to each other by bolts, screws, or the like.

The connection bracket 444 may be changed in length depending on the magnitude of the force applied to the handle bar 410. The length of the connection bracket 444 and the coupling position of the force sensor 442 may be determined in consideration of the position where the force is transmitted so as to be distinguished from the vibration transmitted to the cart 10 from the ground. Thus, even though vibration occurs in the vertical direction of the cart 10, it is possible to mechanically minimize noise interfering with the determination of the force direction by adjusting the length of the connection bracket 444 and the coupling position of the force sensor 442. Therefore, it is possible to perform accurate detecting and reduce manufacturing costs since a complicated control algorithm is not required.

Meanwhile, the support frame 446 in the form of a plate having a predetermined area, and is coupled to the rear upper side of the body 100 as described above. The support frame 446 has a size enough to cover and support the pair of connection brackets 444 and the pair of force sensors 442. The one ends of the force sensors 442 are coupled to both sides on the surface of the support frame 446. The part of the support frame 446 to which each force sensor 442 is coupled is defined as a sensor fixing part 446a. On the surface of the support frame 446, there may be provided a body coupling part 446b that is mounted to the body 100 and then coupled to a cover frame (not illustrated) for covering the force sensing module 440. These coupling parts are coupled to each other by bolts, screws, or the like.

The force sensor 442 and connection bracket 444 provided at one side of the handle bar 410 should not interfere with the force sensor 442 and connection bracket 444 provided at the other side of the handle bar 410. Accordingly, on the support frame 446, the one-side force sensor 442 and connection bracket 444 and the other-side force sensor 442 and connection bracket 444 may be disposed in a zigzag manner while facing each other.

That is, in FIG. 3, the left force sensor 442 and connection bracket 444 may be disposed above, and the right force sensor 442 and connection bracket 444 may be disposed below. Alternatively, they may be disposed in reverse. This structure is to transmit the force applied through the handle support frames 430 to the force sensors 442.

In the cart according to the first embodiment of the present invention having the above-mentioned configuration, a process will be described in which force sensing and power assist are performed.

Referring to FIG. 3, the user may push the handle bar 410 to move the cart 10 forward. In this case, the user presses the handle bar 410 in the P1 direction. The force applied to the handle bar 410 is transmitted to the connection brackets 444 through the handle support frames 430.

When a lever structure is applied to the structure of the present invention, the handle bar 410 is a point of force to which a force is applied, and each force sensor 442 is a point of action that acts upon the applied force. The lower end of each handle support frame 430 is a point of support for transmitting a force to the associated force sensor 442. Thus, the force applied to the handle bar 410 is transmitted to the force sensor 442 by the handle support frame 430 to deform the force sensor 442, so that detection is possible.

Referring to FIG. 5, the external force transmitted to the left handle support frame 430 is transmitted to the right force sensor 442 in the longitudinal direction (the direction indicated by the arrow of FIG. 5) of the upper connection bracket 444. Similarly, the external force transmitted to the right handle support frame 430 is transmitted to the left force sensor 442 in the longitudinal direction of the lower connection bracket 444.

The respective force sensors 442 installed at the respective sides of the handle support frames 430 receive external force by the connection brackets 444. The portion of each force sensor 442 receiving the external force is a free end. Since the direction of the external force is the P1 direction and each handle support frame 430 and each connection bracket 444 are also pressed in the P1 direction, the free end of the force sensor 442 is also deformed under the force in the P1 direction.

In this case, the detected value of the force sensor 442 may be transmitted to the control unit 130, and the control unit 130 may determine that a force is applied in the P1 direction based on the detected value. In the present invention, the detection of the direction in which the force is applied is defined as “force sensing”.

Subsequently, the control unit 130 may determine that there is required “power assist” to supply an assist force in the P1 direction. The control unit 130 may control the drive unit 110 to generate electrical power and transmit the generated electrical power to the wheels 300. The wheels 300 are driven by the assist force transmitted by the control unit 130.

For example, if the force of the user for pushing the cart 10 is “10”, the force pushing the cart 10 through the power assist function may be additionally provided by “90”. Accordingly, the cart 10 moves at the same force and speed as the pushing force of “100”, but the force actually applied by the user is “10”. Therefore, the user can move the cart 10 with less force, thereby improving the convenience of the user.

On the contrary, referring to FIG. 3, the user may pull the handle bar 410 to move the cart 10 rearward. In this case, the user pulls the handle bar 410 in the P2 direction. The force applied to the handle bar 410 is transmitted to the connection brackets 444 through the handle support frames 430.

Referring to FIG. 5, the external force transmitted to the left handle support frame 430 is transmitted to the right force sensor 442 in the longitudinal direction of the upper connection bracket 444. Similarly, the external force transmitted to the right handle support frame 430 is transmitted to the left force sensor 442 in the longitudinal direction of the lower connection bracket 444.

The respective force sensors 442 installed at the respective sides of the handle support frames 430 receive external force by the connection brackets 444. The portion of each force sensor 442 receiving the external force is a free end. Since the direction of the external force is the P2 direction and each handle support frame 430 and each connection bracket 444 are also pressed in the P2 direction, the free end of the force sensor 442 is also deformed under the force in the P2 direction.

In this case, the detected value of the force sensor 442 may be transmitted to the control unit 130, and the control unit 130 may determine that a force is applied in the P2 direction based on the detected value. Subsequently, the control unit 130 may provide the power assist function to supply an assist force in the P2 direction.

In the above embodiment, the force sensor 442 detects when a force is applied in the P1 or P2 direction so that the control unit 130 provides the power assist function, in which case it can be said to operate in a “power assist mode”. If no force is applied in the P1 or P2 direction, the control unit 130 may determine that the user drives the cart 10 in a manual mode.

Although not illustrated in the drawings, the handle bar 410 may also be provided with a switch for transmitting a power assist mode on/off signal to the control unit 130, instead of the load cell. In this case, the power assist mode may be executed immediately by the user operating the switch.

In the above embodiment, the structure has been described in which each connection bracket transmits a force to the force sensor disposed on the opposite side thereof while having a predetermined length. However, the shape of the connection bracket may be modified to support the force sensor close to each handle support frame 430.

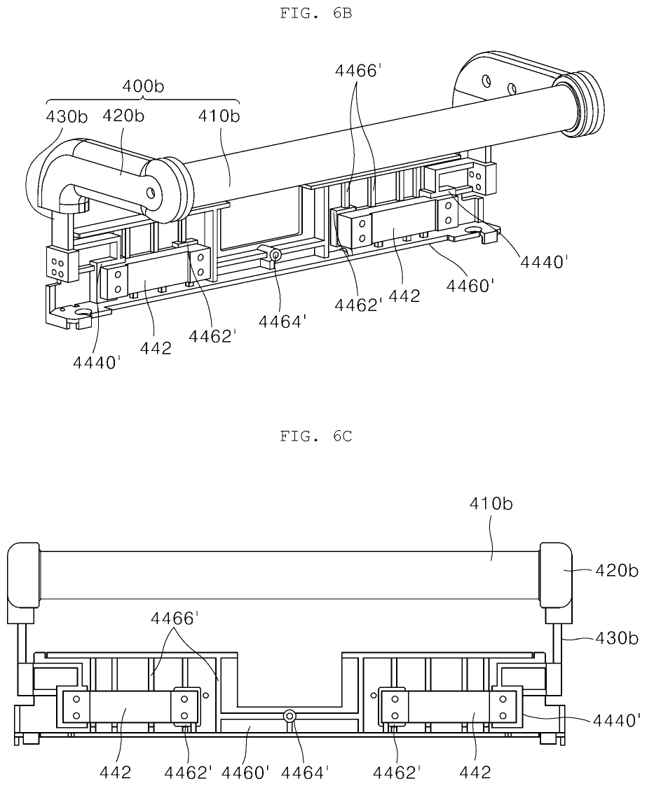

FIG. 6A is a perspective view illustrating a handle assembly according to a second embodiment of the present invention. FIGS. 6B and 6C are views illustrating a handle assembly according to a modified example of the second embodiment.

As illustrated in FIG. 6A, the handle assembly, which is designated by reference numeral 400a, according to the second embodiment of the present invention may include the same handle bar 410a, handle cover frames 420a, and handle support frames 430a as in the first embodiment. Similar to the first embodiment, the force sensing module (not illustrated) may include the force sensors 442 and the support frame (not illustrated). Each connection bracket 4440 may be shaped to connect the associated force sensor 442 adjacent to each handle support frame 430a.

That is, the connection bracket 4440 is a substantially “ [symbol] ”-shaped bracket. The connection bracket 4440 has a sensor seating part 4442 formed at one end thereof to be coupled to the force sensor 442 and a frame coupling part 4444 formed at the other end thereof to be coupled to the handle support frame 430. In the present embodiment, the connection bracket 4440 has been described as having a substantially “ [symbol] ” shape. However, the present invention is not limited thereto as long as the external force transmitted by the handle support frame 430 may be transmitted to the adjacent force sensor 442.

According to the second embodiment of the present invention, since the left connection bracket 4440 transmits a force to the left force sensor 442 and the right connection bracket 4440 transmits a force to the right force sensor 442, the transmission path of force is shortened. Thus, the cart 10 is less affected by the external vibration generated in the vertical direction of the cart 10. Therefore, it is possible to provide the optimal handle assembly 400a by appropriately changing and applying the shape of each connection bracket 4440 and the installation position of each force sensor 442 according to the use environment of the cart 10.

Alternatively, the mounting structure of the force sensor 442 may be implemented more stably by modifying the structure of the second embodiment.

As illustrated in FIGS. 6B and 6C, the handle assembly, which is designate by reference numeral 400b, according to the modified example of the second embodiment of the present invention may include the same handle bar 410b, handle cover frames 420b, and handle support frames 430b as in the second embodiment. A force sensing module (not illustrated) may include force sensors 442, connection brackets 4440′, and a support frame 4460′. The force sensors 442 are mounted at the same height and mutually symmetrical positions on the support frame 4460′.

Each of the connection brackets 4440′ may be shaped, similar to the second embodiment, to connect the associated force sensor 442 adjacent to each handle support frame 430b.

Similar to the first embodiment, the support frame 4460′ is coupled to the rear upper side of the body 100. The support frame 4460′ has a size enough to cover and support the pair of connection brackets 4440′ and the pair of force sensors 442. A sensor fixing part 4432′ is formed at each of both sides of the support frame 4460′ so that one end of the associated force sensor 442 is coupled to the sensor fixing part 4432′. Similar to the first embodiment, on the surface of the support frame 4460′, there may be provided a body coupling part 4464′ coupled to a cover frame (not illustrated) for covering the force sensing module. The support frame 4460 ‘may have the same shape as in the first embodiment, or may be configured to have a plurality of support ribs 4466’ having a bar shape, not a plate shape, to reduce the weight thereof.

The pair of force sensors have different heights in the first embodiment, and the pair of force sensors have the same height in the second embodiment. If the heights of the force sensors are different, the transmission lengths of force are different even though the same force is applied, so that the detected values of the force sensors may be different to distinguish the left and right sides only by the detected values. However, the area occupied by the force sensing module in the first embodiment is larger than that in the second embodiment.

Accordingly, if necessary, by adding a control algorithm for distinguishing the left and right directions or installing the force sensors at different heights to reduce the occupied area of the force sensing module, the design may be performed in a different manner, such as simply configuring the control algorithm, even though the area is increased.

Meanwhile, the force sensing module may sometimes need to be disposed at the lower side of the body, not the upper side thereof, at the request of consumers or for design reasons. In this case, since the force sensing module is closer to the ground, noise generation due to vibration may be greater compared to when the force sensing module is disposed at the upper side of the body. To solve this issue, there is proposed a structure in which a force sensing module includes a hinge part in a third embodiment of the present invention (a detailed description of the same configuration as in the first embodiment will be omitted).

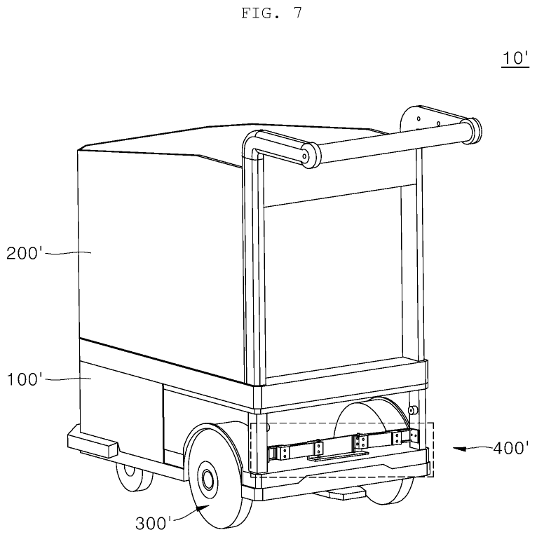

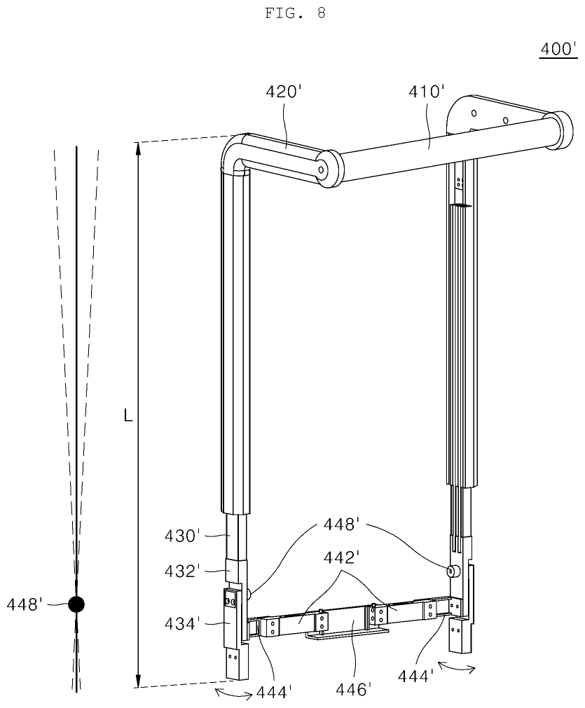

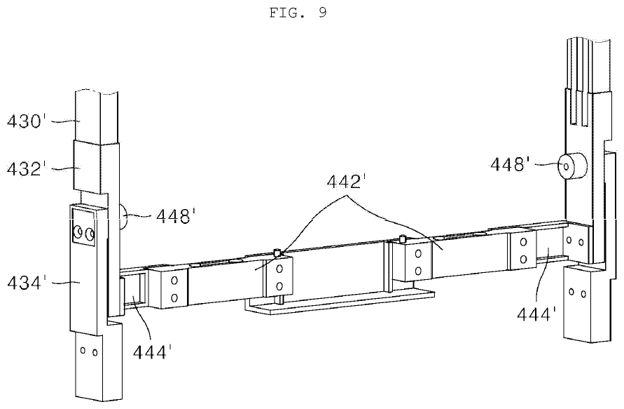

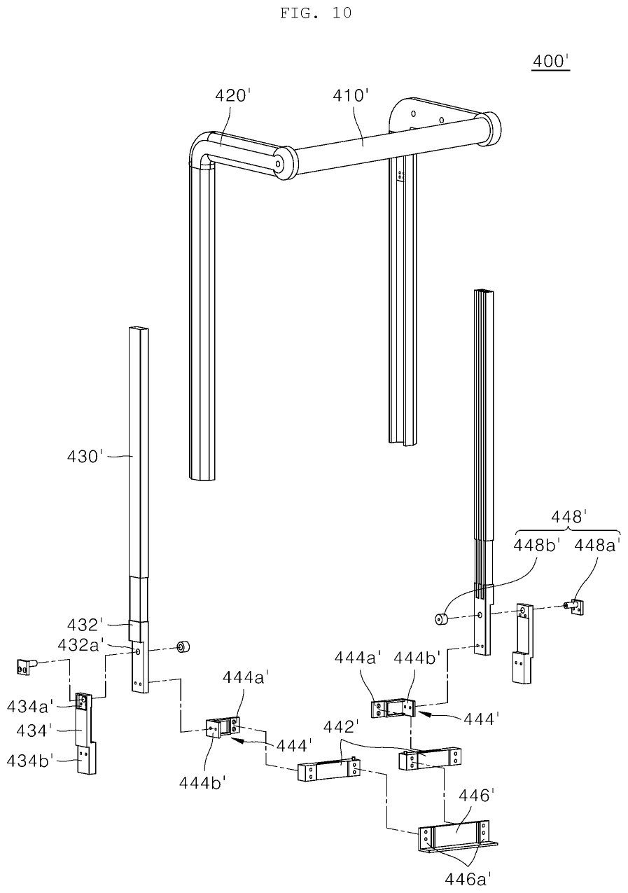

FIG. 7 is a rear perspective view illustrating the rear of a cart according to a third embodiment of the present invention. FIG. 8 is a perspective view illustrating the handle assembly of FIG. 7. FIG. 9 is an enlarged perspective view illustrating a main part of the handle assembly of FIG. 7. FIG. 10 is an exploded perspective view illustrating the handle assembly of FIG. 7.

As illustrated in FIGS. 8 to 10, the handle assembly, which is designated by reference numeral 400′, according to the third embodiment of the present invention may include a force sensing module 440′ provided at the lower portion of a body 100′. The handle assembly 400′ includes a handle bar 410′, a pair of handle cover frames 420′, and a pair of handle support frames 430′. In addition, the handle assembly 400′ includes a pair of first subframes 432′ and a pair of second subframes 434′, and the force sensing module 440′ is connected to the second subframes 434′.

As illustrated in FIG. 8, the handle cover frames 420′ extend to the lower portion of the body 100′, and the handle support frames 430′ are inserted into the respective handle cover frames 420′. One end of each of the handle cover frames 420′ is coupled to the handle bar 410 and the other end thereof is bent and extends downward. The upper side of the handle cover frame 420′ in the longitudinal direction L thereof may be coupled to the body 100′. That is, each handle cover frame 420′ may be coupled to the body 100′ such that the coupling part of the handle cover frame 420′ to the body 100′ is movable enough to transmit a force applied in a P1 or P2 direction to the associated handle support frame 430′.

The handle support frame 430′ is a straight bar disposed in the longitudinal direction L. The lower end of the handle support frame 430′ is partially exposed out of the handle cover frame 420′. However, the handle support frame 430′ is not exposed out of the body 100′ since it is accommodated in the body 100′. The lower end of the handle support frame 430′ is coupled with an associated one of the first subframes 432′ and an associated one of the second subframes 434′.

One end of the first subframe 432′ is coupled to the lower end of the handle support frame 430′ and the other end thereof extends downward. The second subframe 434′ and a hinge part 448′ are coupled to the upper side of the downward extension part of the first subframe 432′. This part is defined as a hinge coupling part 432a′. In addition, each force sensor 442′ is coupled to the lower end of the downward extension part of the associated first subframe 432′ by an associated connection bracket 444′.

Each of the second subframes 434′ is rotatably coupled to the associated first subframe 432′ by the associated hinge part 448′. The upper end of the second subframes 434′ is coupled to the first subframe 432′ by the hinge part 448′ and the other end thereof extends downward. The other end of the second subframes 434′ may be fixedly accommodated in the body 100′. The upper end of the second subframes 434′ is defined as a hinge coupling part 434a′.

The portion of the first or second subframe 432′ or 434′ where the associated hinge coupling part 432a′ or 434a′ is formed may be thinner than the portion where the hinge coupling part 432a′ or 434a′ is not formed such that the coupling portion of the first subframe 432′ and the second subframe 434′ is not thicker than the handle support frame 430′.

Alternatively, the second subframe 434′ may be directly connected to the lower end of the handle support frame 430′ without separately providing the first subframe 432′.

The force sensing module 440″includes a force sensor 442′ composed of a load cell, a connection bracket 444′ for connecting the force sensor 442′ to the associated first subframe 432′, and a support frame 446′ for supporting the force sensor 442′. The force sensor 442′ and the connection bracket 444′ may consist of a pair of force sensors and a pair of connection brackets, respectively. The support frame 446′ may be a single support frame.

Each of the connection brackets 444′ couples an associated one of the force sensors 442′ to the associated first subframe 432′. The connection bracket 444′ has a sensor seating part 444a′ formed at one end thereof so that the force sensor 442′ is coupled to the sensor seating part 444a′ by bolts or the like. The connection bracket 444′ has a frame coupling part 444b′ formed at the other end thereof so that the first subframe 432′ is coupled to the frame coupling part 444b′ by bolts or the like.

Sensor fixing parts 446a′ are provided at both ends of the support frame 446′ so that the force sensors 442′ are coupled to the respective sensor fixing parts 446a′ by bolts or the like. The support frame 446′ is fixedly coupled to the center of the lower portion of the body 100′, and the force sensors 442′ are coupled to both ends of the support frame 446′. Thus, from among both ends of each force sensor 442′, the end of the force sensor 442′ coupled to the support frame 446′ is a fixed end. From among both ends of each force sensor 442′, the end of the force sensor 442′ coupled to the associated first subframe 432′ is a free end since it may have a certain amount of displacement. As the free end of the force sensor 442′ is deformed, the direction of the force applied to the handle bar 410′ is detected.

The hinge part 448′ includes a hinge shaft 448a′ inserted through the first and second subframes 432′ and 434′, and a stopper 448b′ coupled to the end of the hinge shaft 448a′ to prevent the separation of the hinge shaft 448a′. The hinge part 448′ rotatably supports the lower end of the first subframe 432′ relative to the second subframe 434′.

In the cart according to the embodiment of the present invention having the above-mentioned configuration, a process will be described in which force sensing and power assist are performed.

Since the lower end of the second subframe 434′ is fixed on the body 100′ but its upper end is not fixed thereon, the upper end of the second subframe 434′ is slightly movable compared to the lower end thereof.

The upper end of the first subframe 432′ is coupled to the handle support frame 430′, and the lower end of the first subframe 432′ is rotatably coupled to the second subframe 434′ but is not fixed to the body 100′. Thus, the lower end of the second subframe 434′ is rotatable about the hinge part 448′ in the direction indicated by the lower arrow of FIG. 8.

The handle support frame 430′ is inserted into the handle cover frame 420′ and the other end thereof is coupled to the first subframe 432′. Thus, the upper end of the handle support frame 430′ is slightly movable about the hinge part 448′ (the dotted line in the L direction of FIG. 8 refers to the displacement of the handle support frame).

A force is applied to the handle bar 410′ in the P1 or P2 direction (see FIG. 3). Accordingly, when the force is applied to the handle bar 410′ in the P1 or P2 direction, the handle support frame 430′ and the first subframe 432′ are moved about the hinge part 448′ in the direction of the arrow (see the direction of the lower arrow of FIG. 8).

If the hinge part 448′ is not provided, it may be difficult for the force sensor 442′ to detect a direction of force because the displacement of the handle support frame 430′ or the first subframe 432′ is small. Therefore, the hinge part 448′ is provided to amplify the displacement of the handle support frame 430′ or the first subframe 432′ so that the force sensor 442′ can easily detect the direction of force. Even in this case, in all coupling structures, the direction of force allows a degree of freedom only in the P1 and P2 directions (the direction of movement of the cart) and does not allow a degree of freedom in the vertical direction of the cart 10. Accordingly, it is possible to provide the power assist function by detecting the direction of force without considering vertical noise due to the vibration generated on the ground.

In addition, when the principle of the lever is applied to the present embodiment, the handle bar 410′ is a point of force, the force sensor 442′ is a point of action, and the hinge part 448′ is a point of support. Even if a small force is applied to the point of force, a force larger than the force applied to the point of force acts on the point of action as the point of support moves away from the point of force. Thus, since the force applied to the force sensor 442′ is increased even though the force applied to the handle bar 410′ is small, the force is easily separated from the vibration transmitted from the ground. Therefore, noise is easily removed and the control algorithm is simplified.

When the user pushes the handle bar 410′ in the P1 direction to move the cart 10 forward, the handle support frame 430′ and the first subframe 432′ are pushed in the P1 direction relative to the hinge part 448′. Since the force sensor 442′ is coupled to the lower end of the first subframe 432′, the free end of the force sensor 442′ is also deformed under the force in the P1 direction.

In this case, the detected value of the force sensor 442′ may be transmitted to the control unit 130, and the control unit 130 may determine that a force is applied in the P1 direction, based on the detected value. Subsequently, the control unit 130 may determine that there is required “power assist” to supply an assist force in the P1 direction. The control unit 130 may control the drive unit 110 to generate electrical power and transmit the generated electrical power to the wheels 300. The wheels 300 are driven by the assist force transmitted by the control unit 130.

On the contrary, when the user pushes the handle bar 410′ in the P2 direction to move the cart 10 rearward, the handle support frame 430′ and the first subframe 432′ are pulled in the P2 direction relative to the hinge part 448′. Since the force sensor 442′ is coupled to the lower end of the first subframe 432′, the free end of the force sensor 442′ is also deformed under the force in the P2 direction.

In this case, the detected value of the force sensor 442′ may be transmitted to the control unit 130, and the control unit 130 may determine that a force is applied in the P2 direction, based on the detected value. Thus, the control unit 130 supplies an assist force in the P2 direction.

The above-mentioned embodiments have a structure in which the load cell as a force sensor is installed at the upper or lower portion of the cart body, not within the handle bar which is a point of action of the force directly transmitted, and the force applied to the handle bar is amplified and transmitted to the load cell. Since the magnitude of the force transmitted to the load cell is amplified through the above structure, a large difference occurs between the magnitude of the vibration transmitted from the ground and the magnitude of the force transmitted to the load cell. Therefore, it is possible to easily distinguish and separate the force transmitted to the load cell from the vibration as noise to be removed, thereby simplifying the control algorithm.

According to the present invention, it is possible to improve user's convenience since the user can easily move the cart by detecting the direction, in which a user's force is applied, to provide the assist force (power assist function) in that direction.

In addition, according to the present invention, it is possible to separate the force applied to the handle from noise by installing the load cell at an optimum position that allows the force to be distinguished from the vibration transmitted from the ground. Therefore, it is possible to perform accurate detection without being affected by noise and to achieve an increase in control efficiency and a reduction in manufacturing cost since the complicated control algorithm is not required for noise separation.

While the present invention has been described with respect to the embodiments illustrated in the drawings, the present invention is not limited thereto. It will be apparent to those skilled in the art that various changes and modifications may be made without departing from the spirit and scope of the invention as defined in the following claims. In addition, even though the operation and effect according to the configuration of the present invention are not explicitly described while the above embodiments of the present invention are described, it is obvious that predictable effects should also be recognized by the corresponding configuration.

### INDUSTRIAL APPLICABILITY

The present invention provides a cart that can be used in various manners in the fields of commerce, leisure, logistics, etc.

1.-18. (canceled)

19. A cart handle assembly, comprising:
a handle bar locatable at one side of a cart to receive an external force in a direction of movement of the cart, the handle bar including a first side and a second side; and
a force sensing module including:
a connection bracket located at the first side and the second side of the handle bar and configured to be provided on a body of the cart, the connection bracket being moved in a direction of the external force to the handle bar;
a force sensor coupled to the connection bracket to detect a direction of movement of the connection bracket; and
a support frame supporting the force sensor.

20. The cart handle assembly according to claim 19, wherein the force sensor includes a first end and a second end, and
wherein the first end of the force sensor is coupled to the connection bracket and the second end of the force sensor is coupled to the support frame.

21. The cart handle assembly according to claim 20, wherein the support frame is fixable to the body of the cart.

22. The cart handle assembly according to claim 21, further comprising:
a first handle cover frame coupled to the first side of the handle bar;
a second handle cover frame coupled to the second side of the handle bar;
a first handle support frame coupled to the first handle cover frame; and
a second handle support frame coupled to the second handle cover frame.

23. The cart handle assembly according to claim 22, wherein the first handle support frame and the second handle support frame each include a first end extending in a first direction and a second end extending in a second direction, the first direction being different than the second direction.

24. The cart handle assembly according to claim 23, wherein the first handle support frame and the second handle support frame each has an “L” shape.

25. The cart handle assembly according to claim 22, wherein the connection bracket includes a first end connected to the first side of the handle bar and a second end connected to the second side of the handle bar.

26. The cart handle assembly according to claim 25, wherein the first end of the connection bracket is connected to the first handle support frame, and
wherein the second end of the connection bracket is connected to the second handle support frame.

27. The cart handle assembly according to claim 22, further comprising:
a pair of first subframes, each first subframe having a first end and a second end, the first end of each first subframe being coupled to the first end of a respective one of the first handle support frame and the second handle support frame;
a pair of second subframes, each second subframe having a first end and a second end, the first end of each second subframe being coupled to the second end of a respective one of the first handle support frame and the second handle support frame; and
a hinge part coupling each first subframe to the respective second subframe.

28. The cart handle assembly according to claim 27, wherein the connection bracket is coupled to the second end of each of the pair of first subframes.

29. A cart, comprising:
a body including:
a driver to generate power; and
a controller configured to control the driver;
a wheel coupled to the body to move the body;
a handle bar provided at a first side of the body to receive an external force applied in a direction of movement of the body, the handle bar including a first side and a second side; and
a force sensing module including:
a connection bracket connected to each of the first side and the second side of the handle bar, the connection bracket movable in a direction of the external force input to the handle bar;
a force sensor coupled to the connection bracket to detect a direction of movement of the connection bracket; and
a support frame supporting the force sensor,
the controller being configured to transmit the power generated by the driver to the wheel according to the direction of movement of the connection bracket detected by the force sensor.

30. The cart according to claim 29, wherein the force sensor includes a first end and a second end, and
wherein the first end of the force sensor is coupled to the connection bracket and the second end of the force sensor is coupled to the support frame.

31. The cart according to claim 30, wherein the support frame is fixed to the body of the cart to support the second end of the force sensor.

32. The cart according to claim 31, further comprising:
a first handle cover frame coupled to the first side of the handle bar;
a second handle cover frame coupled to the second side of the handle bar;
a first handle support frame coupled to the first handle cover frame; and
a second handle support frame coupled to the second handle cover frame.

33. The cart according to claim 32, further including a first subframe having a first end and a second end, the first end of the first subframe being coupled to the first end of a respective one of the first handle support frame and the second handle support frame,
wherein the connection bracket is coupled to the second end of the first subframe.

34. A cart, comprising:
a body including:
a driver to generate power; and
a controller configured to control the driver;
a wheel coupled to the body to move the body;
a handle assembly including:
a handle bar to receive an external force applied in a direction of movement of the body; and
a handle support frame extending from the handle bar to transmit the force applied to the handle bar; and
a force sensing module including:
a force sensor connected to the body to detect the force transmitted from the handle support frame; and
a support frame supporting the force sensor,
the controller being configured to transmit the power generated by the driver to the wheel according to the direction of movement of the handle bar detected by the force sensor.

35. The cart according to claim 34, wherein the force sensor includes a first end and a second end,
wherein a first end of the force sensor is fixedly coupled to the handle support frame and a second end of the force sensor is a free end, and
wherein force sensor is deformable by the force transmitted from the handle support frame to detect the force.

36. The cart according to claim 35, wherein the handle assembly further includes a subframe coupled to a lower end of the handle support frame to transmit the force applied to the handle support frame to the force sensor.

37. The cart according to claim 36, wherein the subframe has a rotating part disposed adjacent to the force sensor.

38. The cart according to claim 36, wherein the support frame is fixed to the lower portion of the body of the cart to support the second end of the force sensor.
